(19) United States
(12) Patent Application Publication
(10) Pub. No.: US 2004/0179034 A1
(43) Pub. Date: Sep. 16, 2004

(54) Apparatus and method for displaying background images (themes) for computer and handheld computer devices

(76) Inventor: David Ray Burritt, Bromfield, CO (US)

Correspondence Address: David Ray Burritt, 1350 Bellaire, Broomfield, CO, 80020, US

(21) Appl. No.: 10/783,736

(22) Filed: Feb. 20, 2004

Related U.S. Application Data
(60) Provisional application No. 60/450,419, filed on Feb. 26, 2003.

(51) Int. Cl. G09G 5/00

(52) U.S. Cl. 345/744; 345/747; 345/746; 345/765; 345/619

(57) ABSTRACT

This invention describes a method where the background image (sometimes known as a theme) of a computer is dynamically controlled based upon real-time information received via some kind of network connection. The network connection can be either wired or wireless. This patent application is mainly targeted at handheld computers (typically known as PDAs) and also PDA/cell phone hybrid devices. However, it could really apply to any computer device that has the ability to display a background.

### CROSS REFERENCE TO RELATED APPLICATIONS

A provisional patent describing this invention was applied for on Feb. 26, 2003 (No. 60/450,419).

### STATEMENT REGARDING FEDERALLY SPONSORED RESEARCH OR DEVELOPMENT

No part of this invention was the result of any federally sponsored research and development.

### TECHNICAL FIELD

This invention relates to how background images are displayed for computer and handheld computer devices.

### BACKGROUND OF THE INVENTION

Within the prior art, it is well known how to display a background image on a computer monitor or handheld screen. Within the industry, these images are commonly known as ‘Themes’. Within this document, the following terms shall be used:

Theme: ‘theme’ shall mean the background image that is displayed on a computer monitor or the built-in display of handheld computer.

Handheld Computer: The term ‘handheld computer’ shall mean any of the following:

A self-contained portable computer, which has a means of communicating with a data network. A common name for these devices is PDA. Palm Pilots and Pocket PCs fall into this category as well as a plurality of other handheld devices constantly entering the market.

A self contained portable computer which has a means of communicating with a data network and also has the capability of making voice calls on a voice network (not necessarily at the same time). These devices are a hybrid of a cell phone and a PDA.

A cell phone which has the capability of connecting to data and/or voice networks (not necessarily at the same time) and also has a display and the capability of displaying images on the cell phone's screen. If the cell phone performs voice calls via Voice Over IP then connectivity to voice networks is not necessary since voice calls can be placed over the data network using Voice Over IP technology.

The current art allows the user to specify what ‘theme’ will be displayed on his/her screen. There are also well known ways for the user to specify a list of ‘themes’ which the computer theme selecting algorithm may cycle through. However, the user may desire a ‘theme’ which matches a set of criteria that the user may be interested in. For example, the user may want a theme to match the current weather in a particular city. He or she may want the theme to match how a stock is performing. In the past, handheld computers were not able to get real time information because they did not have a dynamic connection to the Internet/WAN (Wide Area Network) or to a server which has the information which they could use to determine an appropriate ‘theme’. Recent advances in the technology now make it possible for handheld computers to get real time information even if they are not physically connected to the owner's main computer (commonly known as being sync'd).

However, with the recent advances in handheld technology, all the ‘theme selection’ algorithms still use a static list of themes and do not take advantage of networking technology which is now available in today's handhelds.

### SUMMARY OF THE INVENTION

The aforementioned problems are solved and a technical advance is achieved in the art by an apparatus and method that uses a computer program which goes out to the Internet to get information which can then be used to determine which theme is used.

### BRIEF DESCRIPTION OF THE DRAWING

FIG. 1 illustrates, in block diagram form, an embodiment of the invention.

FIG. 2 illustrates, in block diagram form, another embodiment of the invention.

FIG. 3 illustrates, in block diagram form, another embodiment of the invention.

FIG. 4 illustrates, in block diagram form, another embodiment of the invention.

FIG. 5 illustrates, in block diagram form, another embodiment of the invention.

FIG. 6 illustrates, in flowchart form, how the theme switching algorithm could work. The figure uses current weather as an example. However, any real time information could be used.

### DETAILED DESCRIPTION

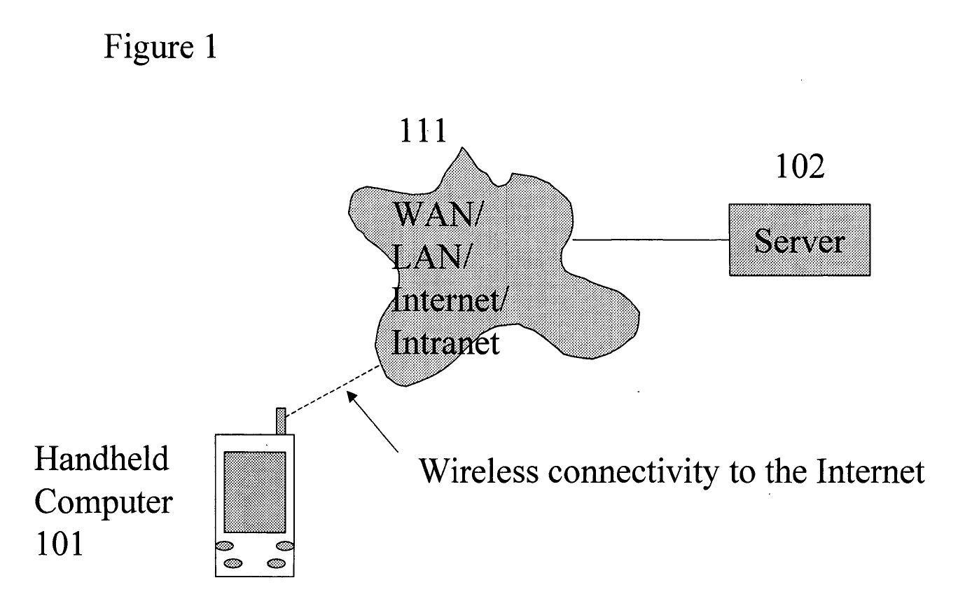

FIG. 1 illustrates an embodiment for implementing the invention. Handheld computer 101 has connectivity to the Internet (WAN (Wide Area Network)) 111 via any available wireless protocol (e.g., 802.11, GSM, GPRS, CDPD). The handheld computer connects to server 102 (e.g., web server) in order to get real time information. Once the information has been collected, a computer program operating in the handheld can analyze the data and select an appropriate ‘theme’ to display to the user

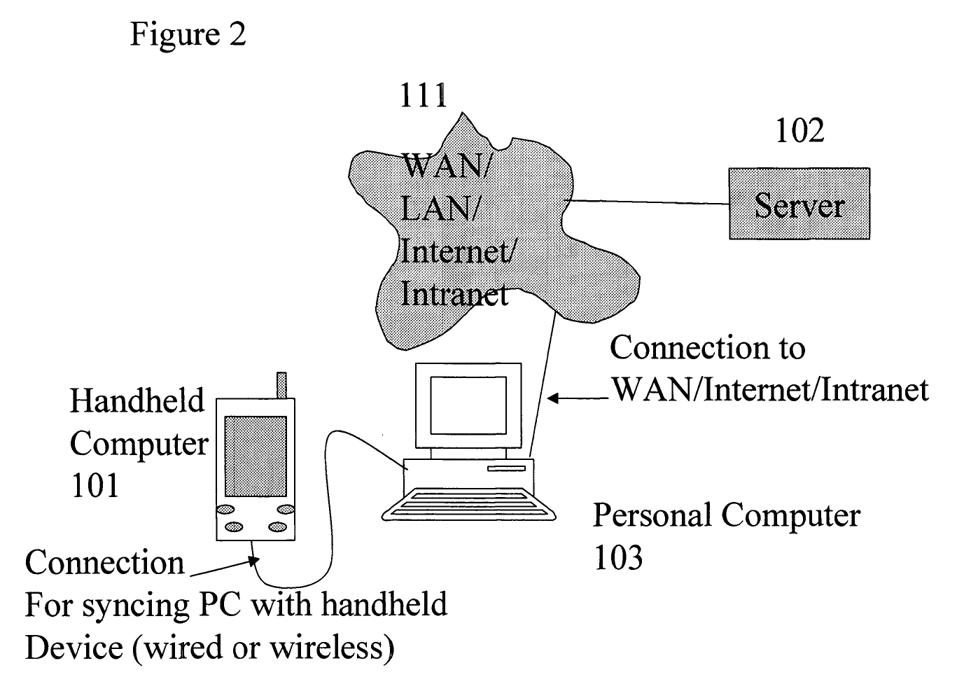

FIG. 2 illustrates another embodiment for implementing the invention. Handheld computer 101 has connectivity to the Internet through host computer 103 which in turn has access to the Internet (WAN) 111. The manner (Dial-up connection, T1, DSL, Cable Modem) in which the host computer has access to the Internet is irrelevant. The handheld computer connects to server 102 (e.g., web server) in order to get real time information. Once the information has been collected, a computer program operating in the handheld can analyze the data and select an appropriate ‘theme’ to display to the user. The computer program running in the handheld may also go to a server and download an appropriate ‘theme’.

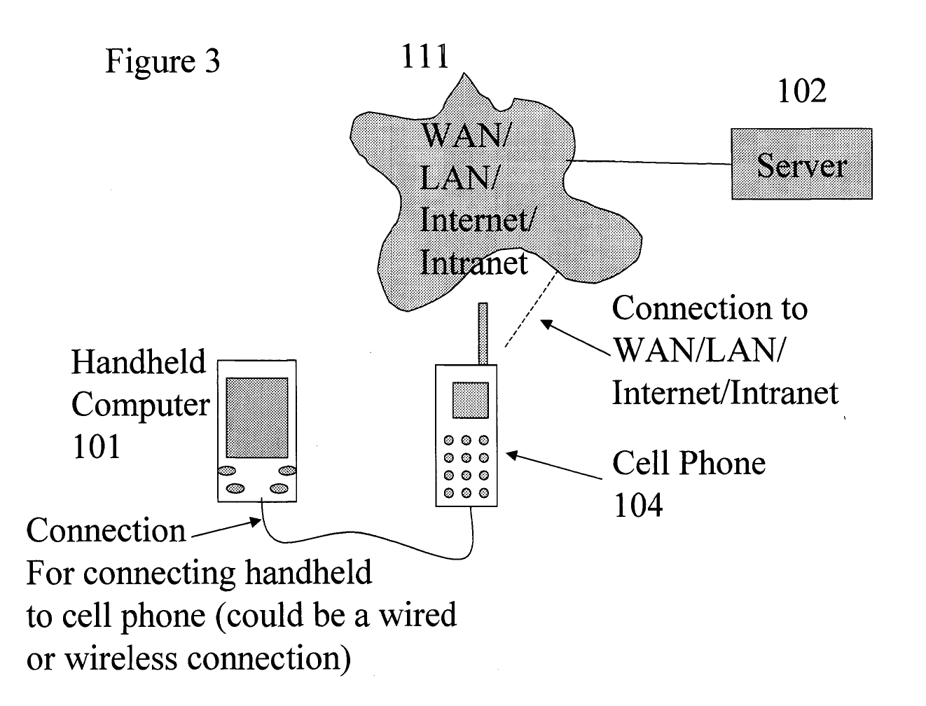

FIG. 3 illustrates another embodiment for implementing the invention. Handheld computer 101 has connectivity to the Internet through cell phone 104. The handheld computer connects to server 102 (e.g., web server) in order to get real time information. Once the information has been collected, a computer program operating in the handheld can analyze the data and select an appropriate ‘theme’ to display to the user. The computer program running in the handheld may also go to a server and download an appropriate ‘theme’.

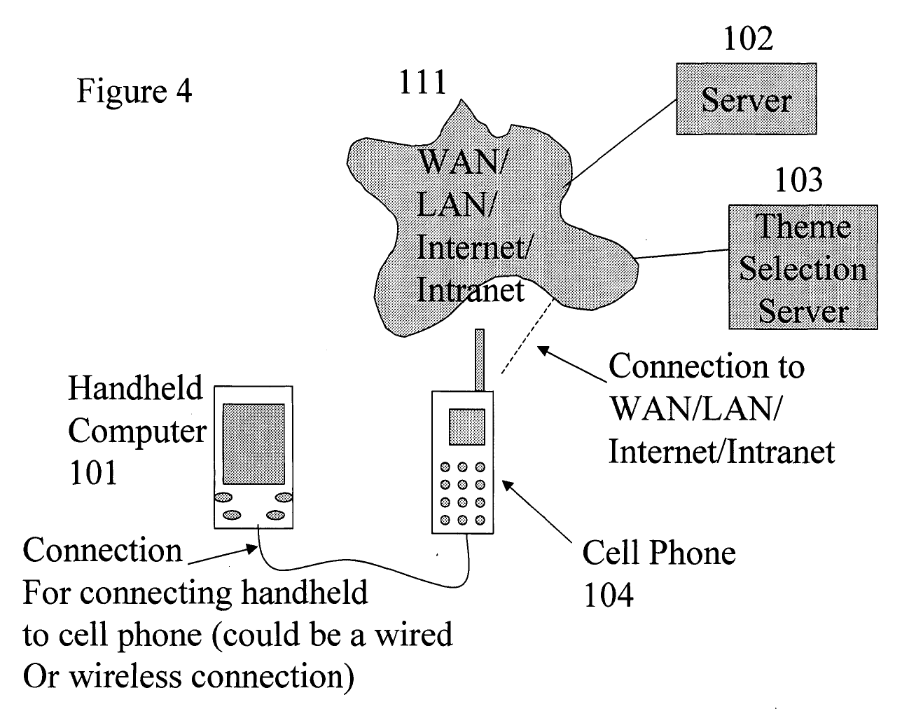

FIG. 4 illustrates another embodiment for implementing the invention. Handheld computer 101 has connectivity to the Internet through cell phone 104. The handheld computer connects to server 102 (e.g., web server) in order to get real time information. Once the information has been collected, a computer program operating in the handheld can analyze the data and select an appropriate ‘theme’ to display to the user. The handheld computer can then contact another server 103 to request a particular theme. This server (103) may then return the actual theme or an indication of what the theme should be. The server (103) may calculate the theme when the handheld requests it, or may have calculated it ahead of time in anticipation of the handheld request. Actually, servers 102 and 103 could be the same server.

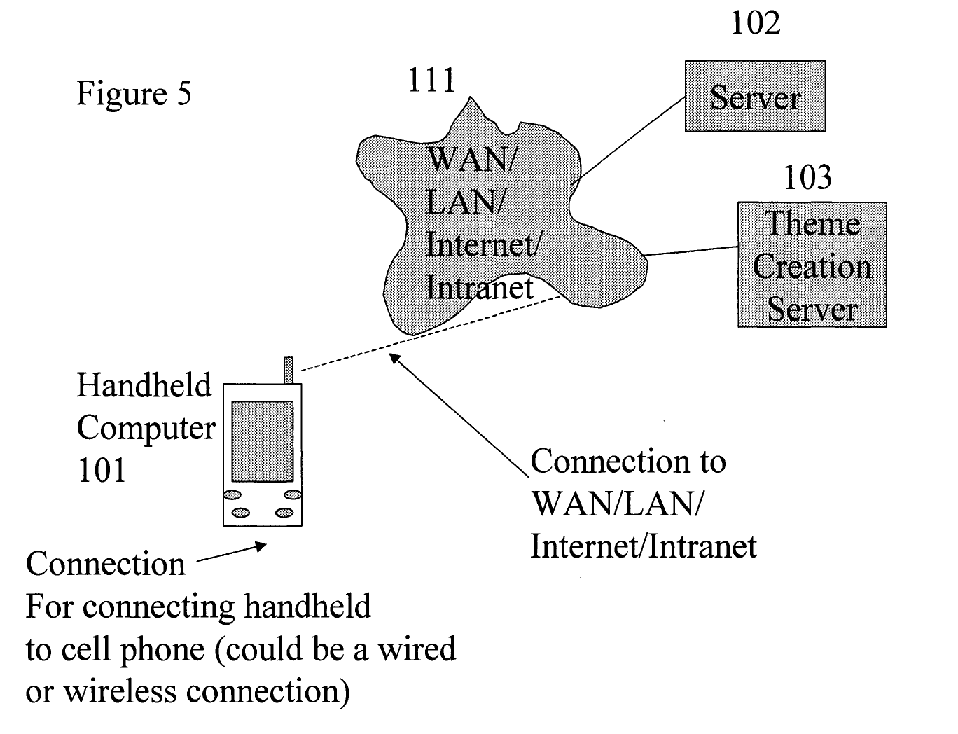

FIG. 5 illustrates another embodiment for implementing the invention. Handheld computer 101 has connectivity to the Internet (WAN (Wide Area Network)) 111 via any available wireless protocol (e.g., 802.11, GSM, GPRS, CDPD). The handheld computer connects to server 102 (e.g., web server) and requests the server to select an appropriate theme. The handheld computer can then contact another server 103 to request a particular theme. This server (103) may then return the actual theme or an indication of what the theme should be. The server (103) may calculate the theme when the handheld requests it, or may have calculated it ahead of time in anticipation of the handheld request. Actually, servers 102 and 103 could be the same server.

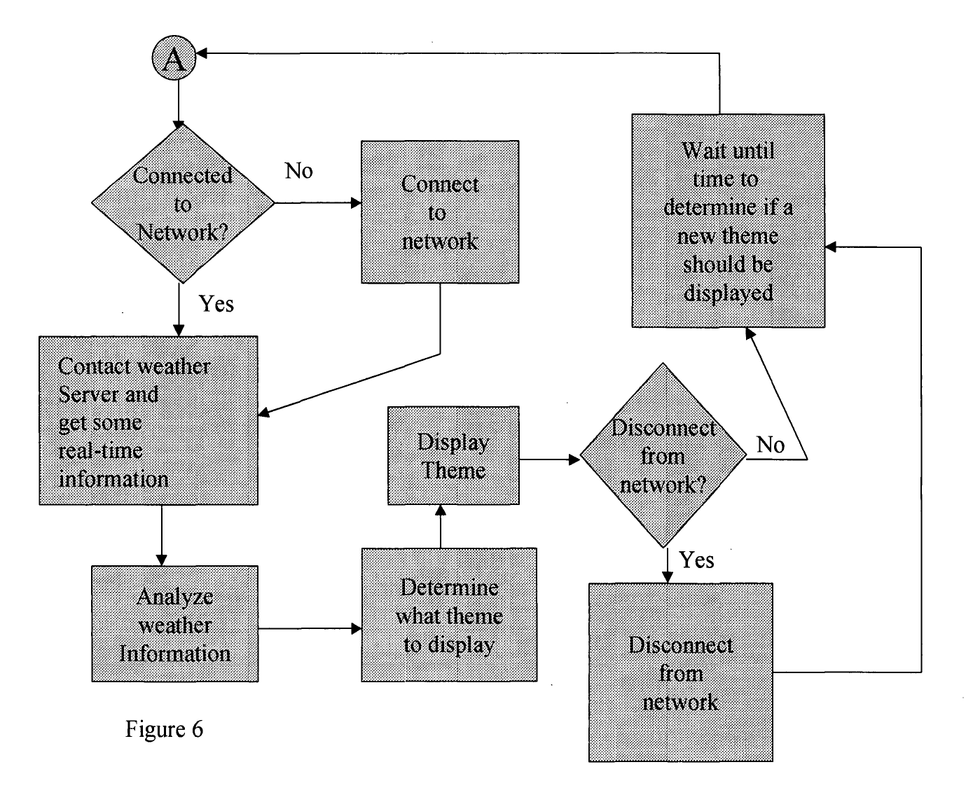

FIG. 6 illustrates how the theme selection algorithm could work. Execution starts at Point A. The application determines if the handheld device is currently connected to the network. If not, then steps must be taken to connect the device to the network. This could be done either programmatically or by instructing the user to connect the device to the network. Once connected the application contacts the server. In this example this could be a weather server to get weather for a particular area. The weather server returns the current information and the application then analyzes it. Once the application has analyzed the data it determines what an appropriate theme is. For example, if the current weather was (20 degrees (Fahrenheit)) and snowing then the application might select a theme with snow in it. Once the theme has been selected, the application displays that theme. The manner in which the theme is displayed is not discussed because it is a well known procedure for those skilled in the art. The application can then determine if it is necessary to disconnect from the network. If it decides to disconnect then the network connection will be torn down. If not, then the connection would be left up. The application then would either exit or suspend itself until it is appropriate to check the real-time weather information again. The exact sequence of when the application disconnects from the network is not important, as long as it does it after the information is received from the server.

What is claimed is:

1. A method for a handheld computer to select a ‘theme’ based on real time information.

2. A method for a server to select a theme and, when a handheld computer connects to it via a WAN (Wide Area Network) or LAN (Local Area Network) inform the handheld computer which theme to use.

3. A method for a server to pre-select a theme and when a handheld computer connects to it via a WAN or LAN inform the handheld computer which theme to use.

4. The method of claims 1, 2, and 3 plus the ability to load the theme from the handheld's main memory storage area

5. The method of claims 1, 2, and 3 plus the ability to load the theme from the handheld's auxiliary or external storage area (if it has such an area).

6. The method of claims 1, 2, and 3 plus the ability to load the theme from an external server

7. The method of claims 1, 2, and 3 plus the ability to take an image from a web cam or other real-time image (e.g., current radar weather image) and convert it to an image suitable for displaying as a ‘theme’
While the invention has been described by means of specific embodiments, numerous modifications and variations could be made thereto by those skilled in the art without departing from the scope and spirit of the invention set forth in the claims.
